(19) United States
(12) Patent Application Publication
(10) Pub. No.: US 2023/0243601 A1
(43) Pub. Date: Aug. 3, 2023

(54) Thermal Energy Storage Devices, Systems Containing Such Devices for Buildings, and Methods of Using the Same

(71) Applicant: IBACOS, Inc., Pittsburgh, PA (US)

(72) Inventor: Andrew Poerschke, Pittsburgh, PA (US)

(21) Appl. No.: 18/104,667

(22) Filed: Feb. 1, 2023

Related U.S. Application Data
(60) Provisional application No. 63/305,701, filed on Feb. 2, 2022.

(51) Int. Cl. F28D 20/02

(52) U.S. Cl. CPC F28D 20/021; F28D 20/028

(57) ABSTRACT

A thermal energy storage device that includes an air distribution conduit and a phase change material. The phase change material is embedded or integrated onto at least an outer portion or inner portion of the air distribution conduit. The energy storage system for buildings includes the thermal energy storage device and an air distribution apparatus that provides air into the device, which is in fluid communication with the air distribution apparatus.

### CROSS REFERENCE TO RELATED APPLICATION

This application claims the benefit of U.S. Provisional Application No. 63/305,701, filed Feb. 2, 2022, which is incorporated herein by reference in its entirety.

### BACKGROUND OF THE INVENTION

### Field of the Invention

The present invention is directed to thermal energy storage devices, systems containing the thermal energy storage devices for use in buildings, as well as methods for using the same to control thermal energy.

### Description of Related Art

As homes become more interactive energy assets for the utility grid, new technologies need to be developed to allow greater energy storage and shifting of peak electrical loads while maintaining or improving occupant comfort. Current residential vapor compression heating, ventilation, and air conditioning (HVAC) equipment uses electrical energy to move thermal energy based on the immediate demand of the thermostat. This thermal energy is “consumed” coincident with the time of demand, which causes peak demand issues at the utility grid level on a daily and seasonal basis. Reducing the peak load issues at the utility grid level is of great value to electric utilities, especially as they incorporate more variable output energy sources.

Thus, it would be desirable to provide devices and systems for buildings that can store transferred heat and provide a thermal buffer for residential HVAC equipment for lowering peak demand on the electrical grid and shifting energy demand to match the output of variable renewable electricity sources.

### SUMMARY OF THE INVENTION

In some non-limiting embodiments, the present invention is directed to a thermal energy storage device that includes an air distribution conduit and a phase change material. The phase change material is embedded or integrated onto at least an outer portion or inner portion of the air distribution conduit. The phase change material can comprise a paraffin, a salt hydrate, or a combination thereof. A thermal conductivity enhancing additive can also be mixed with the phase change material to improve the rate of energy transfer.

In certain non-limiting embodiments, the phase change material is sandwiched between integral layers. The integral layers can be formed from a plastic, a metal, or a combination thereof. In some non-limiting embodiments, the phase change material is encapsulated in a separate blanket. The blanket can be wrapped around an outer portion and/or inner portion of the air distribution conduit to provide a continuous row of encapsulated phase change materials that extend around the outer portion and/or inner portion of the air distribution conduit. The blanket can also be imbedded within an inner liner or outer liner of the air distribution conduit.

In certain non-limiting embodiments, the air distribution conduit comprises one or multiple concentric layers formed within an interior of the air distribution conduit, in which the concentric layers comprise phase change materials. The thermal energy storage device can include additional components, such as thermally conductive enhancements formed into at least a portion of the air distribution conduit and/or insulation formed onto an outer portion of the air distribution conduit.

The present invention also includes a thermal energy storage system for buildings comprising the previously described thermal energy storage device and an air distribution apparatus that provides air into the device, which is in fluid communication with the air distribution apparatus. The system can further include other components, such as an air handling unit connected to a return air manifold and a supply air return, as well as temperature and pressure sensors.

In certain non-limiting embodiments, the system includes a controller that is in operable communication with the air distribution apparatus and/or the thermal energy storage device, one or more computer-readable storage mediums in operable communication with the controller, and contains programming instructions that, when executed, cause the controller to perform multiple tasks.

The thermal energy storage device can be in fluid communication with the air distribution device through one or more control dampers. The system can also include at least one air distribution conduit without a phase change material. The air distribution conduits with and without phase change materials can be secured in a framing device.

In some non-limiting embodiments, the system comprises multiple thermal energy storage devices in which at least some of the devices have different phase change materials with different phase change temperatures to offer thermal energy storage in both heating and cooling modes.

In certain non-limiting embodiments, the programming instructions include instructions and logic to reduce or increase total airflow volume that reduces or increases the supply air temperature and accelerates phase transition of the phase change material. The total airflow volume can be controlled by increasing or decreasing the total airflow resistance of the airflow distribution apparatus by adjusting settings of the control dampers.

The present invention further includes a method of storing and discharging thermal energy in a thermal energy storage system for buildings. The method includes subjecting the thermal energy storage device of the thermal energy storage system previously described to a temperature that causes the phase change material to go through a latent transition and store thermal energy, and distributing air through the thermal energy storage device to discharge stored energy and provide conditioned air.

The present invention also includes the following clauses.

Clause 1: A thermal energy storage device comprising: an air distribution conduit; and a phase change material, wherein the phase change material is embedded or integrated onto at least an outer portion or inner portion of the air distribution conduit.

Clause 2: The thermal energy storage device according to clause 1, wherein the phase change material comprises a paraffin, a salt hydrate, or a combination thereof.

Clause 3: The thermal energy storage device according to any one of the preceding clauses, wherein the phase change material is sandwiched between integral layers.

Clause 4: The thermal energy storage device according to clause 3, wherein the integral layers are formed from a plastic, a metal, or a combination thereof.

Clause 5: The thermal energy storage device according to any one of clauses 1 and 2, wherein the phase change material is encapsulated in a separate blanket.

Clause 6: The thermal energy storage device according to clause 5, wherein the blanket is wrapped around an outer portion and/or inner portion of the air distribution conduit to provide a continuous row of encapsulated phase change materials that extend around the outer portion and/or inner portion of the air distribution conduit.

Clause 7: The thermal energy storage device according to any one of clauses 5 and 6, wherein the blanket is embedded within an inner liner or outer liner of the air distribution conduit.

Clause 8: The thermal energy storage device according to any one of the preceding clauses, wherein the air distribution conduit comprises multiple concentric layers formed within an interior of the air distribution conduit, and wherein the concentric layers comprise phase change materials.

Clause 9: The thermal energy storage device according to any one of the preceding clauses, further comprising thermally conductive enhancements formed into at least a portion of the air distribution conduit.

Clause 10: The thermal energy storage device according to any one of the preceding clauses, further comprising insulation formed onto an outer portion of the air distribution conduit.

Clause 11: A thermal energy storage system for buildings comprising: the thermal energy storage device according to any one of the preceding clauses 1-10; and an air distribution apparatus that provides air into the device which is in fluid communication with the air distribution apparatus.

Clause 12: The system according to clause 11, further comprising an air handling unit connected to a return air manifold and a supply air return.

Clause 13: The system according to any one of clauses 11 and 12, further comprising temperature and pressure sensors.

Clause 14: The system according to any one of clauses 11-13, further comprising a controller that is in operable communication with the air distribution apparatus and/or the thermal energy storage device, one or more computer-readable storage mediums in operable communication with the controller, and contains programming instructions that, when executed, cause the controller to perform multiple tasks.

Clause 15: The system according to any one of clauses 11-14, wherein the thermal energy storage device is in fluid communication with the air distribution device through one or more control dampers.

Clause 16: The system according to any one of clauses 11-15, further comprising at least one air distribution conduit without a phase change material.

Clause 17: The system according to clause 16, wherein the air distribution conduits with and without phase change materials are secured in a framing device.

Clause 18: The system according to any one of clauses 11-17, wherein the system comprises multiple thermal energy storage devices in which at least some of the devices have different phase change materials with different phase change temperatures to offer thermal energy storage in both heating and cooling modes.

Clause 19: The system according to any one of clauses 14-18, wherein the programming instructions comprise instructions and logic to reduce or increase total airflow volume that reduces or increases the supply air temperature and accelerates phase transition of the phase change material.

Clause 20: The system according to clause 19, wherein the total airflow volume is controlled by increasing or decreasing total airflow resistance of the airflow distribution apparatus by adjusting settings of control dampers.

Clause 21: A method of storing and discharging thermal energy in a thermal energy storage system for buildings, the method comprising: subjecting the thermal energy storage device of the thermal energy storage system according to any one of clauses 11-20 to a temperature that causes the phase change material to go through a latent transition and store thermal energy; and distributing air through the thermal energy storage device to discharge stored energy and provide conditioned air.

### BRIEF DESCRIPTION OF THE DRAWINGS

FIG. 1 is a front cross-sectional view of a thermal energy storage device having phase change materials formed between integral layers according to the present invention;

FIG. 2 is a front cross-sectional view of a thermal energy storage device having phase change materials formed between integral layers as well as convection enhancing fins according to the present invention;

FIG. 3 is a front cross-sectional view of a thermal energy storage device having phase change materials encapsulated in a separate blanket and which is integrated into the inner liner according to the present invention;

FIG. 4 is a front cross-sectional view of a thermal energy storage device having phase change materials encapsulated in a separate blanket and which is formed on the inner liner according to the present invention;

FIG. 5 is a front cross-sectional view of a thermal energy storage device having phase change materials formed between integral layers as well as a concentric layer according to the present invention;

FIG. 6 is a front cross-sectional view of a thermal energy storage device having phase change materials formed between integral layers as well as multiple concentric layers according to the present invention;

FIG. 7 is a front cross-sectional view of a thermal energy storage device having phase change materials formed between integral layers and which has a rectangular shape according to the present invention;

FIG. 8 is a front cross-sectional view of a thermal energy storage device having phase change materials encapsulated in a separate blanket and which has a rectangular shape according to the present invention;

FIG. 9 is a perspective view of a thermal energy storage system according to the present invention;

FIG. 10 is a front cross-sectional view of a thermal energy storage device having phase change materials formed on an outer portion of the conduit according to the present invention; and

FIG. 11 is a front cross-sectional view of a thermal energy storage device having phase change materials formed on an inner portion of the conduit according to the present invention.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

The present invention includes a thermal energy storage device 2 that comprises an air distribution conduit 10, such as an air duct, having a phase change material (PCM) 12. As used herein, “phase change material” refers to materials that absorb and release thermal energy (heat) during the processes of melting and freezing. Non-limiting examples of phase change materials that can be used with the present invention include paraffins, salt hydrates, and the like.

In certain non-limiting embodiments, additional materials are mixed with the PCM 12 to provide additional benefits. For instance, the PCM 12 can be mixed with a thermal conductivity enhancing additive to improve the rate of energy transfer. A non-limiting example of a thermal conductivity enhancing additive is graphite.

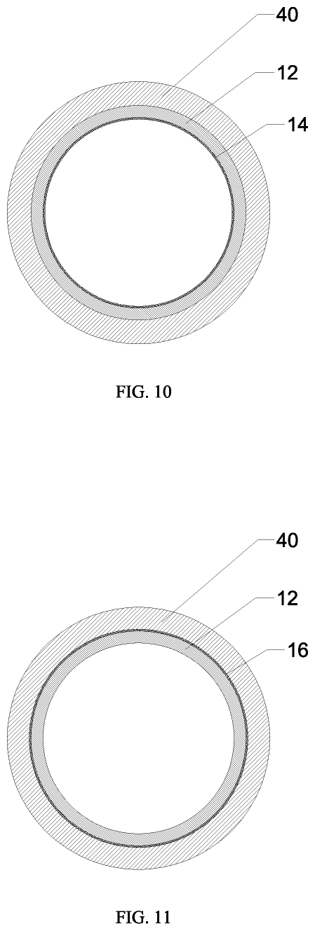

As shown in FIGS. 1-8, the PCM 12, and optionally an additional material such as a thermal conductivity enhancing additive mixed with the PCM 12, can be embedded or integrated into or on at least a portion of the conduit 10. For example, as shown in FIG. 10, the PCM 12 can be embedded or integrated into or on at least an outer portion 14 of the conduit 10. Alternatively, as shown in FIG. 11, the PCM 12 can be embedded or integrated into or on at least an inner portion 16 of the air distribution conduit 10 (e.g., to interact with the air flowing through the air distribution conduit 10). It is appreciated that the PCM 12, and optionally an additional material such as a thermal conductivity enhancing additive mixed with the PCM 12, can be embedded or integrated into or on both an outer portion 14 of the conduit 10 and an inner portion 16 of the conduit 10.

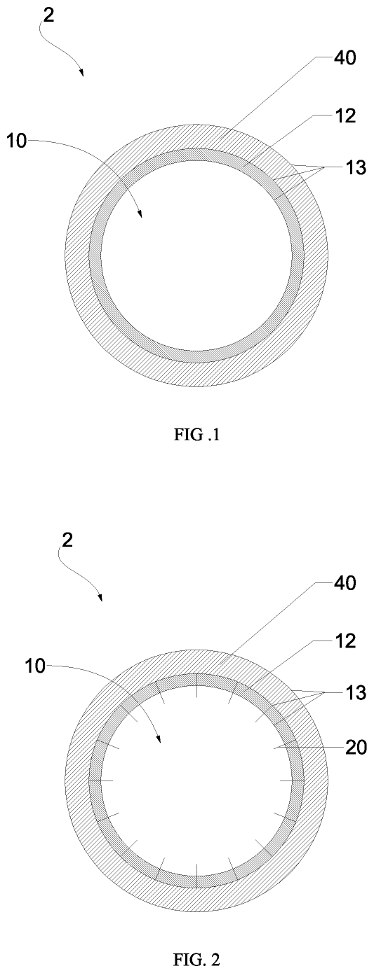

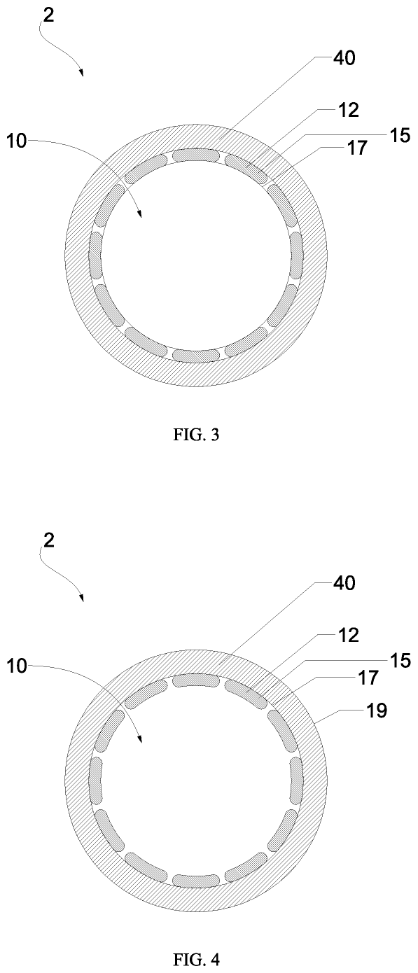

The PCM 12, and optionally an additional material such as a thermal conductivity enhancing additive mixed with the PCM 12, can be incorporated or positioned on the air distribution conduit 10 using various configurations and methods. For example, the PCM 12 can be sandwiched between integral layers 13 of the air distribution conduit 10 as shown in FIGS. 1 and 2, or contained in a separate blanket 15, which is added to an existing air distribution conduit 10 as shown in FIGS. 3 and 4, or both. The integral layers 13 can be formed from thin layers of plastics, metals, or a combination thereof. It is appreciated that the integral layers 13 can have at least a first layer 13 positioned on the outer portion 14 or inner portion 16 of the air distribution conduit 10, at least a second layer 13 opposite and facing the first layer 13, and the PCM 12 positioned and sandwiched between the first and second layers 13.

In certain non-limiting embodiments, as shown in FIGS. 3 and 4, the PCM 12, and optionally an additional material such as a thermal conductivity enhancing additive mixed with the PCM 12, is contained in a separate blanket 15. The blanket 15 can comprise the PCM 12 encapsulated at different areas of the blanket 15. For instance, the separate blanket 15 can have various areas of encapsulation in which the PCM 12 is encapsulated, such as being encapsulated in a material comprising a plastic, a metal, or a combination thereof. The PCM 12 may also have multiple layers of encapsulation, including plastics and metals, which may aid the compliance with building codes. As shown in FIGS. 3 and 4, the blanket 15 can be wrapped around the outer portion 14 and/or inner portion 16 of the air distribution conduit 10 so that a continuous row of encapsulated PCMs 12 extends around the outer portion 14 and/or inner portion 16 of the air distribution conduit 10. As further shown in FIG. 3, the blanket 15 can be embedded within the inner liner 17 of the conduit 10. Alternatively, referring to FIG. 4, the blanket 15 can be placed over the inner liner 17. It is appreciated that the blanket 15 can also be associated with the outer liner 19 of the conduit 10 in the same manner as previously described with respect to the inner liner 17.

The PCM 12 can be positioned at various areas of the air distribution conduit 10. In certain non-limiting embodiments, the PCM 12 is located in an air distribution conduit 10 that is a supply duct, so that it is downstream of heating and cooling equipment. The PCM 12 can also be part of an air distribution conduit 10 that is a supply or return duct, depending on the final product conceptualization and specific user application. In another non-limiting embodiment, the PCM 12 is installed in the air distribution conduit 10 that is part of an outdoor air ventilation system to pre-condition outdoor air.

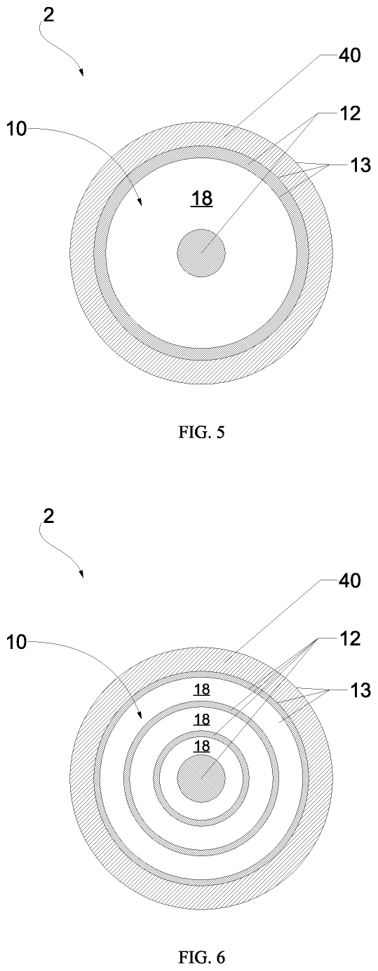

The PCM 12 can be formed from a single layer of material or multiple layers of material, such as the materials previously described that are used to form the PCM 12. In some non-limiting embodiments, as shown in FIGS. 5 and 6, the air distribution conduit 10 includes multiple concentric layers 30 formed within an interior 18 of the air distribution conduit 10. These concentric layers 30 can be formed from the PCM 12, and optionally an additional material, such as a thermal conductivity enhancing additive mixed with the PCM 12.

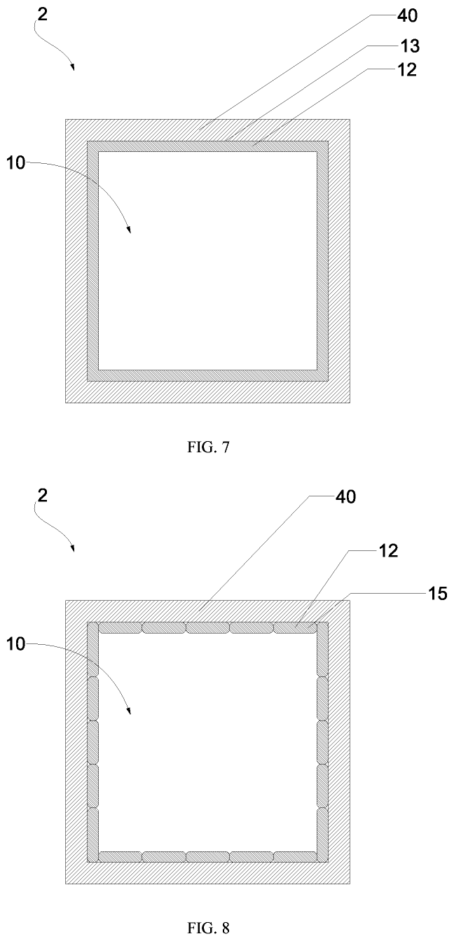

The air distribution conduit 10 can have various shapes and configurations. In certain non-limiting embodiments, as shown in FIGS. 1-6, the air distribution conduit 10 has a round shape with the PCM 12 incorporated or positioned on the air distribution conduit 10 as previously described. In some non-limiting embodiments, as shown in FIGS. 7 and 8, the air distribution conduit 10 has a rectangular shape with the PCM 12 incorporated or positioned on the air distribution conduit 10 as previously described.

The thermal energy storage device 2 can also include additional components. In certain non-limiting embodiments, referring to FIG. 2, the air distribution conduit 10 comprising a PCM 12 further includes thermally conductive enhancements 20 that can increase convection to the entrained air. Non-limiting examples of thermally conductive enhancements 20 include fins or helical groves positioned on or in the PCM 12. In some non-limiting embodiments, the thermal energy storage device 2 can also include insulation 40 on the outside portion 14 of the air distribution conduit 10. The insulation 40 can be secured to the conduit 10 using the previously described integral layers 13, or the insulation 40 can be associated with the inner liner 17 and/or outer liner 19.

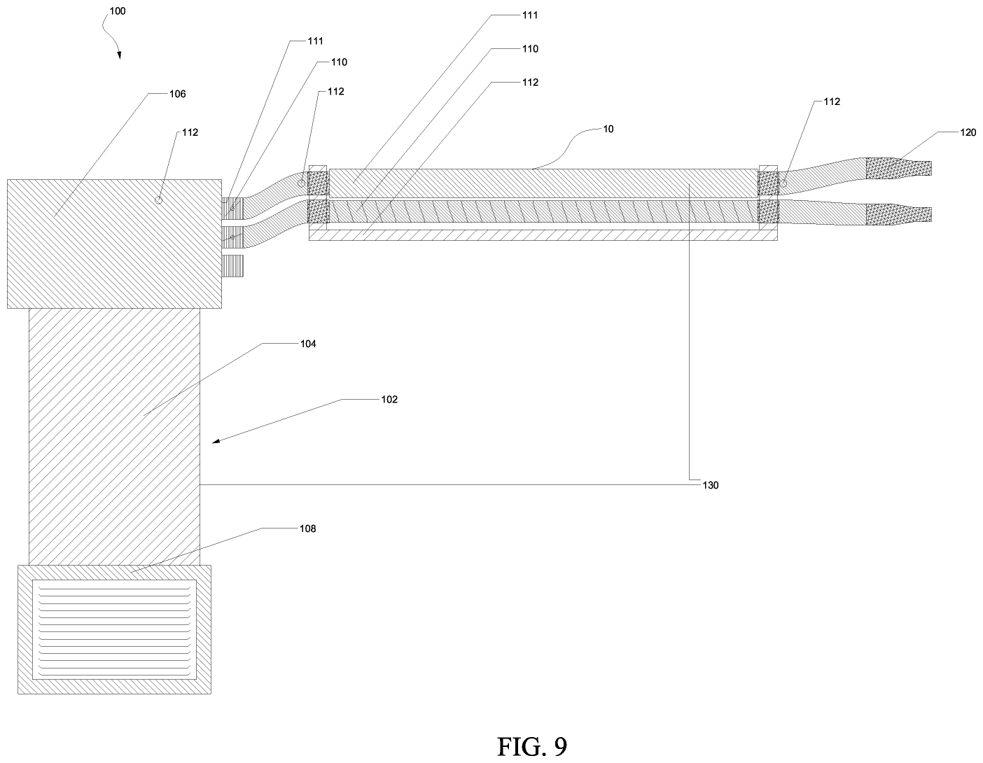

The present invention also includes a thermal energy storage system 100 for use in buildings. It is appreciated that the system 100 can be used in various types of buildings, including various types of residential and commercial buildings. Referring to FIG. 9, the system 100 can include an air distribution apparatus 102 that provides air into the system 100 and the device 2 for storing and controlling energy that is in fluid communication with the air distribution apparatus 102.

It is appreciated that various types of air distribution apparatuses 102 can be used. For example, and as shown in FIG. 9, the air distribution apparatus 102 can comprise an air handling unit 104 connected to a return air manifold 106 and a supply air return 108. It is appreciated that various types of air distribution systems 100 can be used, such as the air distribution apparatus and corresponding components described in U.S. Patent Application Publication No. 2019/0170375, which is incorporated by reference herein in its entirety.

As further shown in FIG. 9, the device 2 can be in fluid communication with the air distribution apparatus 102 by dampers 110 positioned within and/or around the airflow orifices 111 of the manifold 106 that can control the air flow, such as by reducing or preventing airflow into the device 2. In certain non-limiting embodiments, the system 100 can further include temperature and pressure sensors 112 and/or space conditioning equipment controls (thermostats).

The system 100 can also include multiple conduits, in which at least some of the conduits are the previously described air distribution conduits 10 having the PCM 12. As shown in FIG. 9, the system can include standard air distribution conduits 114 (without the PCM 12) and air distribution conduits 10 having the PCM 12. The conduits 114, 10 can be secured in a framing device 116 in which a terminal end 120 of the conduits 114, 10 extends out of the framing device 116. The system 100 can also utilize multiple air distribution conduits 10 having different PCMs 12 that have different phase change temperatures to offer storage in both heating and cooling modes.

The previously described system 100 can be automatically controlled. For example, the system 100 can further include a controller 130 that is in operable communication with the air distribution apparatus 102 and/or the device 2. The controller 130 may include one or more microprocessors, CPUs, and/or other computing devices including, for example, a mobile application device such as a cell phone. One or more computer-readable storage mediums can be in operable communication with the controller 130, and contain programming instructions that, when executed, cause the controller 130 to perform multiple tasks. This includes programming algorithms that allow the controller 130 to automatically control the equipment thermostat to manage the storage of thermal energy. The control algorithms could also respond to utility demands to reduce peak energy, or requests to shift the daily load profile.

In certain non-limiting embodiments, the programming algorithms include instructions and logic to reduce or increase the total airflow volume. Reducing or increasing the total airflow volume can be used to reduce or increase the supply air temperature, which in turn accelerates the phase transition of the PCM 12. In some non-limiting embodiments, the airflow volume is controlled by increasing or decreasing the total airflow resistance of the airflow distribution apparatus, such as by adjusting the setting of the dampers 110.

The previously described thermal energy storage system 100 charges the PCM 12 when excess energy is available on the power grid, or prior to needing to reduce the building's electrical load. During charging, conditioned airflow is directed through the air distribution conduit 10 having the PCM 12 to cause the material to go through a latent transition. The space conditioning equipment may elevate or reduce the air temperature beyond typical operation to accelerate the conduit's 10 phase change.

When energy is stored in the conduit 10, it can operate as a normal conduit 10, and neither add or remove energy from the air-stream, if the air-stream is the same temperature as the PCM 12. In this mode, the conduit 10 could provide an additional airflow path for pressure relief.

When it is desired to discharge the energy stored in the conduit 10, the controller 130 would engage the air handling unit's 104 fan to move air through the conduit 10 without turning on the system's 100 compressor or furnace elements. The PCM 12 would then discharge stored energy and provide the home with conditioned air without the need to run the power consuming compressor or furnace elements.

After the conduit 10 is fully discharged, it could be used as an additional airflow path. For instance, when the system 100 is operating in the opposite mode of the PCM 12 (heating vs. cooling), then the conduit 10 could be used as a flow path without going through a phase change. During this operation, the PCM 12 would increase or decrease in temperature and only store sensible energy.

The conduit 10 may also act as an energy sink and pressure relief path if it is part of a zoned system. Zoned systems must use variable speed equipment, a bypass duct, or over-sized supply duct systems to handle excess pressure when not all zones are calling. A bypass duct lowers the return air temperature, and lowers the energy efficiency of the system 100. The controller 130 could re-direct some of the excess conditioning air into the device 2 to store the energy for future use, or to simply prevent the over-conditioning of non-calling zones. The conduits 10 could be routed to all zones in the building, or only critical zones. The conduits 10 may also be run in parallel to standard non-energy storage conduits 114.

It was found that the devices 2 and systems 100 described herein can store transferred heat and provide a thermal buffer for residential HVAC equipment for lowering peak demand on the electrical grid and shifting energy demand to match the output of variable renewable electricity sources.

Whereas particular embodiments of this invention have been described above for purposes of illustration, it will be evident to those skilled in the art that numerous variations of the details of the present invention may be made without departing from the invention as defined in the appended claims.

The invention claimed is:

1. A thermal energy storage device comprising:
an air distribution conduit; and
a phase change material,
wherein the phase change material is embedded or integrated onto at least an outer portion or inner portion of the air distribution conduit.

2. The thermal energy storage device according to claim 1, wherein the phase change material comprises a paraffin, a salt hydrate, or a combination thereof.

3. The thermal energy storage device according to claim 1, wherein the phase change material is sandwiched between integral layers.

4. The thermal energy storage device according to claim 3, wherein the integral layers are formed from a plastic, a metal, or a combination thereof.

5. The thermal energy storage device according to claim 1, wherein the phase change material is encapsulated in a separate blanket.

6. The thermal energy storage device according to claim 5, wherein the blanket is wrapped around an outer portion and/or inner portion of the air distribution conduit to provide a continuous row of encapsulated phase change materials that extend around the outer portion and/or inner portion of the air distribution conduit.

7. The thermal energy storage device according to claim 5, wherein the blanket is embedded within an inner liner or outer liner of the air distribution conduit.

8. The thermal energy storage device according to claim 1, wherein the air distribution conduit comprises multiple concentric layers formed within an interior of the air distribution conduit, and wherein the concentric layers comprise phase change materials.

9. The thermal energy storage device according to claim 1, further comprising thermally conductive enhancements formed into at least a portion of the air distribution conduit.

10. The thermal energy storage device according to claim 1, further comprising insulation formed onto the outer portion of the air distribution conduit.

11. A thermal energy storage system for buildings comprising:
the thermal energy storage device according to claim 1; and
an air distribution apparatus that provides air into the device which is in fluid communication with the air distribution apparatus.

12. The system according to claim 11, further comprising an air handling unit connected to a return air manifold and a supply air return.

13. The system according to claim 11, further comprising temperature and pressure sensors.

14. The system according to claim 11, further comprising a controller that is in operable communication with the air distribution apparatus and/or the thermal energy storage device, one or more computer-readable storage mediums in operable communication with the controller, and contains programming instructions that, when executed, cause the controller to perform multiple tasks.

15. The system according to claim 11, wherein the thermal energy storage device is in fluid communication with the air distribution device through one or more control dampers.

16. The system according to claim 11, further comprising at least one air distribution conduit without a phase change material.

17. The system according to claim 12, wherein the air distribution conduits with and without phase change materials are secured in a framing device.

18. The system according to claim 11, wherein the system comprises multiple thermal energy storage devices in which at least some of the devices have different phase change materials with different phase change temperatures to offer thermal energy storage in both heating and cooling modes.

19. The system according to claim 14, wherein the programming instructions comprise instructions and logic to reduce or increase total airflow volume that reduces or increases supply air temperature and accelerates phase transition of the phase change material.

20. The system according to claim 19, wherein the total airflow volume is controlled by increasing or decreasing total airflow resistance of the air distribution apparatus by adjusting settings of control dampers.

21. A method of storing and discharging thermal energy in a thermal energy storage system for buildings, the method comprising:
subjecting the thermal energy storage device of the thermal energy storage system according to claim 11 to a temperature that causes the phase change material to go through a latent transition and store thermal energy; and
distributing air through the thermal energy storage device to discharge stored energy and provide conditioned air.
